(19) United States
(12) Patent Application Publication
(10) Pub. No.: US 2001/0044364 A1
(43) Pub. Date: Nov. 22, 2001

(54) Method for producing letter envelopes from a moving web of material

(75) Inventor: Dirk Saas, Winnigen (DE)

Correspondence Address: COLLARD & ROE, P.C., 1077 Northern Boulevard, Roslyn, NY, 11576, US

(73) Assignee: Winkler & Dunnebier Aktiengesellschaft

(21) Appl. No.: 09/829,649

(22) Filed: Apr. 10, 2001

(30) Foreign Application Priority Data
May 17, 2000 (DE) 100 23 999.4

(51) Int. Cl. B31B 1/14

(52) U.S. Cl. 493/187

(57) ABSTRACT

In the manufacture of letter envelopes from a web of material, the web is first imprinted normally and only then divided into so-called cuts or letter envelope blanks cut to size with the help of a rotating punch. In this process, the printed image has to positioned in the correct location within the blank cut to size. In order to accomplish this positioning, a few sample blanks are produced and measured first in a test run of the machine. The deviation of the actual position of the printed image from the target (or nominal) position is determined and a corrective value is accordingly input in the control electronics of the machine drive by the machine operator.

### BACKGROUND OF THE INVENTION

1. Field of the Invention

The invention relates to a method for producing letter envelopes from a moving web of stock material. In particular, the invention relates to a method for positioning a sequence of printed images in their correct positions in relation to a reference edge within envelope blanks cut to size by shaping and separating sections from a web of material after the printing process has been completed.

2. The Prior Art

In producing letter envelopes, a web of material is processed in a great variety of ways in stations connected in line one after the other, before it is finally severed and admitted to other work stations downstream in the form of so-called blanks cut to size.

A basic problem posed when processing this material web is to carry out the various processing steps in the correct phase positions.

One of the first processing steps on the web is to imprint it. The lateral shaping sections and the separation sections are carried out later in a cutting station located downstream. In the printing step, the imprinted image has to be located in a preset position within the blank to be cut to size by the sections, i.e. the imprinting and cutting of the web have to take place in the correct phase positions.

The phase position is adjusted in the course of a short test run of the machine. An imprinted blank produced in this way is taken from the machine as a sample and controlled with respect to the correct position of the imprinted image within the blank cut to size with the help of a real or imagined reference edge.

If a correction of the position of the imprinted image is required, such correction is carried out in conventional machines with a through-extending main driving shaft by turning the printing station against the driving shaft, for example by releasing a clamping connection, or, if only minor corrections are needed, by axially displacing helical gears in the drive train.

With modern machines equipped with individual drives of the stations via servo-drives, the correction of the position of the printed image is carried out by stepping the machine into the desired position. For this purpose, the drive motor the printing gear is actuated in order to advance or retract the printing machine vis-à-vis the drive of the cutting station by minute increments by repeatedly depressing a plus or minus key. This adjustment process is continued until the correct position of the printed image has been visually adjusted within the blank cut to size.

The drawback of such step-by-step (or incremental) positioning of the printed image within the blank is that with more extensive corrective movements, very many of such incremental adjustment steps are required, i.e. the adjustment operation lasts for quite a long time and, furthermore, leads to a high rejection quota.

Therefore, the problem addressed by the invention is to provide a method for producing letter envelopes which permits any correction of the position of the printed image within the blank that may be required to be carried out in one single step irrespective of the magnitude of the required corrective movement.

### SUMMARY OF THE INVENTION

This problem is solved according to the invention by a method including the following steps:

(a) Application of printed images to the material web;

(b) formation of blanks cut to size by carrying out shaping and separating sections in the imprinted material web;

(c) removal of an imprinted blank from the machine;

(d) determination of the actual spacing of the printed image from a reference edge with the help of a blank taken from the machine as a sample;

(e) computing of the difference between the determined actual spacing of the printed image from the reference edge, and of a preset nominal (or target) spacing of the printed image from the reference edge; and

(f) inputting of the difference between the actual and the target spacing as the corrective value in the control electronics.

The advantage of this solution is that the entire corrective movement of the printing station vis-à-vis the cutting station is triggered in one single step by presetting a numerical value. The printing gear is not only adjusted very rapidly in this way, but the amount of collected rejects is minimized as well.

### DESCRIPTION OF THE DRAWINGS

An example of the application of the method as defined by the invention for producing letter envelopes from a moving web of material is shown in the drawings and explained in the following in greater detail.

In the drawings, wherein similar reference characters denote similar elements throughout the several views:

FIG. 1 shows a side view of a part of the web of a letter envelope manufacturing machine comprising a printing station and a cutting station; and

FIG. 2 is a schematic top view of the web zone of a letter envelope manufacturing machine according to FIG. 1.

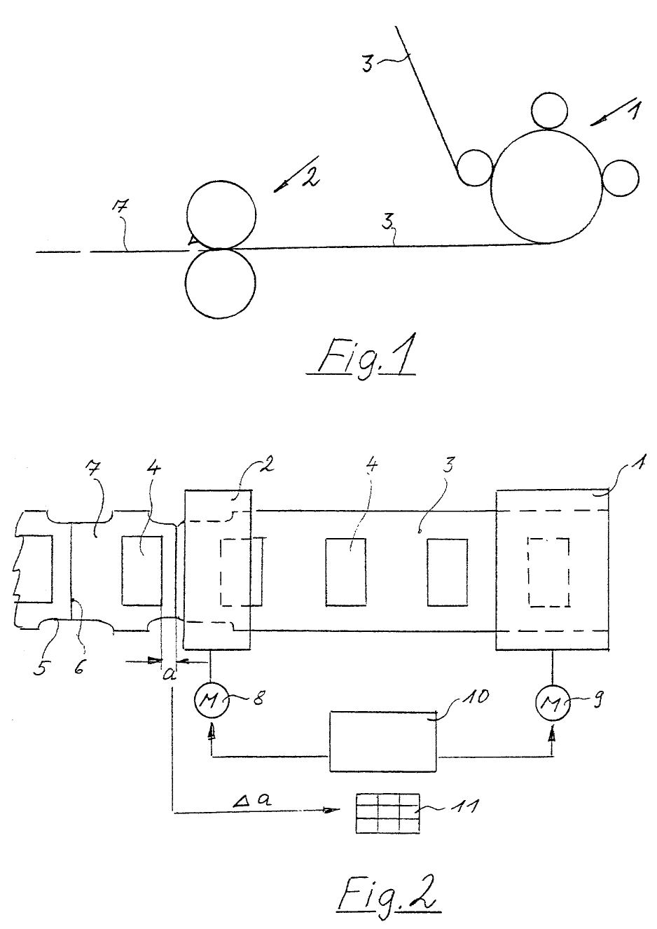

### DETAILED DESCRIPTION OF PREFERRED EMBODIMENTS

The zone of the letter envelope manufacturing machine processing stock in the form of a material web that is of interest in the present case, only relates to a short cutout of the overall machine extending from a printing station 1 to a cutting station 2 which is arranged only a short distance farther downstream. A material web 3 received from a takeoff station (not shown here) is passed through printing station 1 and provided with a continuous sequence of printed images 4 indicated in FIG. 2 as rectangles, and subsequently separated into the blanks 7 with the help of the cutting station 2 by means of the shaping and severing sections 5 and 6, respectively.

Both printing station 1 and cutting station 2, as well as the so-called drawing rolls (not shown in the drawing) for driving material web 3, are equipped with their own drive motors 8 and 9. In the normal operation of the machine, drive motors 8 and 9 are coupled with each other in rigid phase via control electronics 10, so that a phase position, once adjusted, remains preserved irrespective of the speed at which the machine is operating, or other influences.

The coupling between printing station 1 and cutting station 2 in rigid phase is briefly cancelled only for readjustment of the machine, for example after a change in format, in order to permit a change in the relative position of the printed image 4 in relation to the cutting edges 5 or 6.

The following procedure is followed for this purpose:

A few printed images 4 are applied to material web 3 first until at least one of the images has passed through cutting station 2 and at least one blank 7 has thus been produced with the desired printed image 4. The machine is subsequently stopped, or, with a machine driving slowly, an individual blank 7 is taken as a sample and the position of the printed image in relation to a reference edge is measured. In the example shown, it is assumed that the separating section 6 represents the reference edge and the measured actual measure “a” between the rear edge of the printed image 4 and the reference edge 6 amounts to, for example 1 cm. However, a nominal measure of 3 cm, for example, has been preset, which means a difference of 2 cm is present in the direction “late”. In other words, the image has been printed 2 cm too late. For eliminating this deviation, the machine operator inputs into a controller via a keyboard 11 the corrective measure or value, which in the present case thus amounts to 2 cm, in the direction of “earlier”.

The control electronics 10 thereupon releases the coupling in rigid phase between the printing and the cutting stations and causes drive motor 9 of printing station 1 to adjust the printing station by the desired amount and in the desired direction in relation to the position of cutting station 2 whose position remains unchanged.

After the position of printing station 1 has been corrected, the connection in rigid phase between the printing and the cutting stations is re-established, i.e. the machine is ready to operate again; however, now the machine operates with the positioning of the printed image within the blank changed in accordance with the corrected preset value. When the normal operation of the machine is started again, only a few sheets of paper accumulate as rejects, which are collected during the adjustment operation between the printing and the cutting stations.

Beyond the type of positioning of the printed image as defined by the invention and described herein, the conventional adjustment possibility via plus/minus keys already described above as being part of the prior art remains preserved to the machine operator as an additional fine adjustment.

While several embodiments of the present invention have been shown and described, it is to be understood that many changes and modifications may be made thereunto without departing from the spirit and scope of the invention as defined in the appended claims.

What is claimed is:

1. A method for producing letter envelopes from a moving web of material in an envelope producing machine comprising the steps of:
(a) applying printed images to the web;
(b) cutting the web to form at least one blank of a selected size with a printed image;
(c) removing one of said blanks from the machine;
(d) using the removed blank to determine the actual spacing of the printed image from a reference edge of the blank;
(e) computing the difference between the determined actual spacing of the printed image from the reference edge and a preset nominal spacing of the printed image from the reference edge; and
(f) inputting the difference between the actual and the nominal spacing in a controller as a corrective value.

2. A method for positioning a sequence of printed images in correct positions in relation to a reference edge of an envelope blank cut to a selected size following a printing process by shaping and severing sections of an envelope producing machine comprising the steps of:
(a) printing images on a moving web of material;
(b) moving the material web through shaping and severing sections of the machine to form envelope blanks cut to a selected size;
(c) removing one of the imprinted blanks cut to a selected size from the machine;
(d) determining the actual spacing of the printed image from a reference edge within the blank;
(e) computing the difference between the determined actual spacing and a preset spacing value; and
(f) manually inputting the difference as a corrective value into control electronics of the machine.
